(19) United States
(12) Patent Application Publication
(10) Pub. No.: US 2011/0115142 A1
(43) Pub. Date: May 19, 2011

(54) INTERLOCKED VIBRATION REDUCTION MOUNT

(75) Inventors: Todd M. Wirges, Ann Arbor, MI (US); Todd Majewski, Elkhart, IN (US)

(73) Assignee: Freudenbert-NOK General Partnership, Plymouth, MI (US)

(21) Appl. No.: 10/567,296

(22) PCT Filed: Aug. 6, 2004
(86) PCT No.: PCT/US04/25506

§ 371 Date: Jan. 5, 2010

Related U.S. Application Data
(60) Provisional application No. 60/492,918, filed on Aug. 6, 2003.

(51) Int. Cl. F16F 1/38; F16F 7/00; B29C 45/14

(52) U.S. Cl. 267/141; 264/275

(57) ABSTRACT

A vibration reduction mount (10) is provided having an improved construction in which the mount includes a housing element (12) having an opening (30) adapted to receive a core element (14) with the core element (14) being rotatable after insertion into the housing element (12) or interlocking the core element (14) in the housing element (12). An elastomeric material (16) is then injected into the housing element (12) in order to secure the core element (14) within the housing element (12) and to provide an elastomeric spring for reducing vibrations transmitted from a first member to a second member.

### CROSS-REFERENCE TO RELATED APPLICATIONS

This application claims the benefit of U.S. Provisional Application No. 60/492,918, filed on Aug. 6, 2003. The disclosure of the above application is incorporated herein by reference.

### FIELD OF THE INVENTION

The present invention relates to a vibration reduction mount and more particularly, to an improved vibration reduction mount assembly and method of making.

### BACKGROUND OF THE INVENTION

Vibration reduction mounts are commonly used in automotive and non-automotive applications for reducing the transfer of vibrations from one member to another. In automotive applications, vibration reduction mounts are used between the vehicle body and frame as well as between the powertrain system or other components and the vehicle frame or body. In non-automotive applications vibration reduction mounts have been used in household appliances such as washers and dryers and have been used in industrial machinery. While vibration reduction mounts are effective at reducing vibrations, it is still desirable to provide a vibration reduction mount with a less complex assembly and manufacturing process.

### SUMMARY OF THE INVENTION

Accordingly, the present invention provides a vibration reduction mount having an improved construction in which the mount includes a housing element having an opening adapted to receive a core element with the core element being rotatable after insertion into the housing element for interlocking the core element in the housing element. An elastomeric material is then injected into the housing element in order to secure the core element within the housing element and to provide an elastomeric spring for reducing vibrations transmitted from a first member to a second member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of a vibration reduction mount according to the principles of the present invention;

FIG. 2 is a cross-sectional view of the vibration reduction mount taken in a transverse direction to the cross-sectional view of FIG. 1;

FIG. 3 is a perspective illustration of the insertion of the core element into the housing of the vibration reduction mount according to the principles of the present invention;

FIG. 4 is a top plan view showing the core element inserted into the opening in the housing according to the principles of the present invention;

FIG. 5 is a top plan view illustrating the rotation of the core element within the housing subsequent to insertion of the core element into the opening in the housing;

FIG. 6 is a perspective view of the core element inserted into the opening in the housing and rotated to the interlocked position according to the principles of the present invention;

FIG. 7 is a cut away perspective view illustrating the core element within the housing prior to injection of the elastrometric spring material according to the principles of the present invention;

FIG. 8 is a top plan view showing a square core element inserted through a square opening in a housing according to a further embodiment of the present invention; and

FIG. 9 is a top plan view illustrating the rotation of the core element of FIG. 8 to an interlocked position.

### DETAILED DESCRIPTION OF THE PREFERRED EMBODIMENTS

The following description of the preferred embodiment(s) is merely exemplary in nature and is in no way intended to limit the invention, its application, or uses.

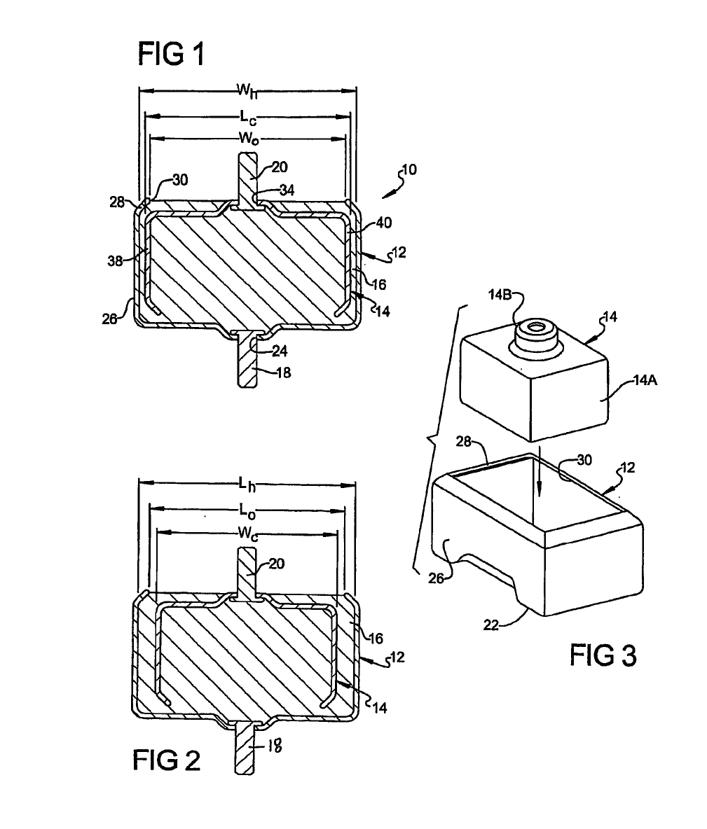

With reference to FIGS. 1-7, the vibration reduction mount 10 and the manufacturing thereof will now be described. The vibration reduction mount 10 includes a housing portion 12 adapted to be mounted to a first support structure and a core element 14 adapted to be mounted to a second support structure. For purposes of the present disclosure, the first and second support structures can include any elements, automotive and non-automotive, for which it is desired to provide a vibration isolating connection therebetween. An elastomeric spring portion 16 is injection molded between the housing 12 and the core element 14. The housing 12 is connected to the first support structure by a fastener 18 and the core element is connected to the second support structure by a fastener 20. Although fasteners 18 and 20 are illustrated as threaded fasteners, it should be understood that other fastening techniques such as rivets, welding and/or other known mechanical fastening means can be utilized for connecting the vibration reduction mount 10 between a first and second support structure in order to reduce the vibration transmitted therebetween.

The housing 12 includes a base portion 22 having an aperture 24 for receiving the fastener 18 therethrough. A side wall portion 26 extends from the base portion 22 and preferably has a rectangular, elliptical, or oblong shape having a major length dimension LH within the interior side walls as illustrated in FIG. 2. The wall portion 24 has a major width dimension WH, smaller than the length dimension LH. The housing 12 also includes an inwardly turned flange portion 28 extending from a second end of the side wall portion 26. The inwardly extending flange portion 28 defines an opening 30 preferably having a rectangular, elliptical or oblong shape having a major length dimension LO which is greater than a major width dimension WO of the opening.

The core member 14 is generally hollow although other configurations including solid configurations can also be utilized. The core member 14 exterior surface preferable has a shape complimentary to the shape of the opening 30 of the housing 12 and therefore preferably include the shapes such as a rectangle, ellipse or oval. The core member 14 includes an insert portion 14A which is inserted into the housing 12 and a mounting portion 14B which extends from the housing through the opening 30. The insert portion 14A of the core member 14 preferably has a length dimension LC that is greater than a width dimension WC. Furthermore, it is preferable that the length dimension LC of the core member is smaller than the length dimension LO of the opening 30 in the housing. Furthermore, it is also desirable that the width dimension WC of the core member 14 is smaller than the width dimension of WO of the opening 30 in the housing 12. The length dimension LC of the core member 14 is preferably longer than the width dimension WO of the opening 30 in the housing 12.

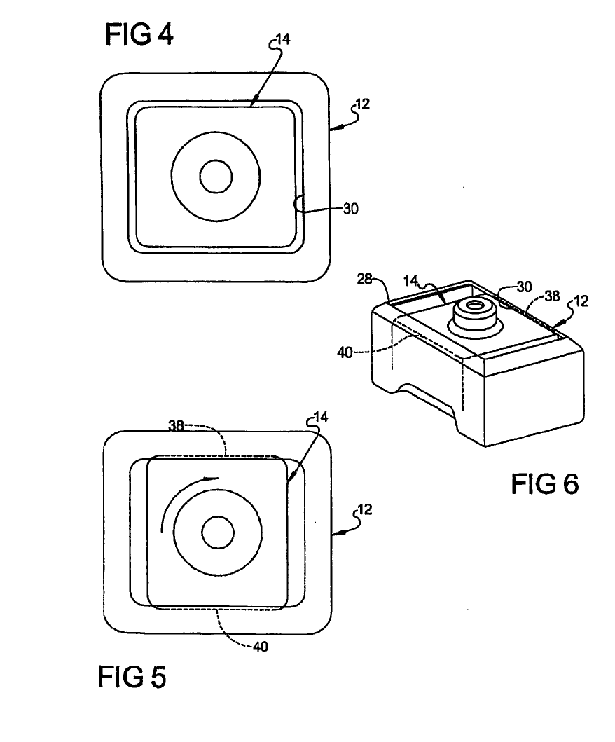

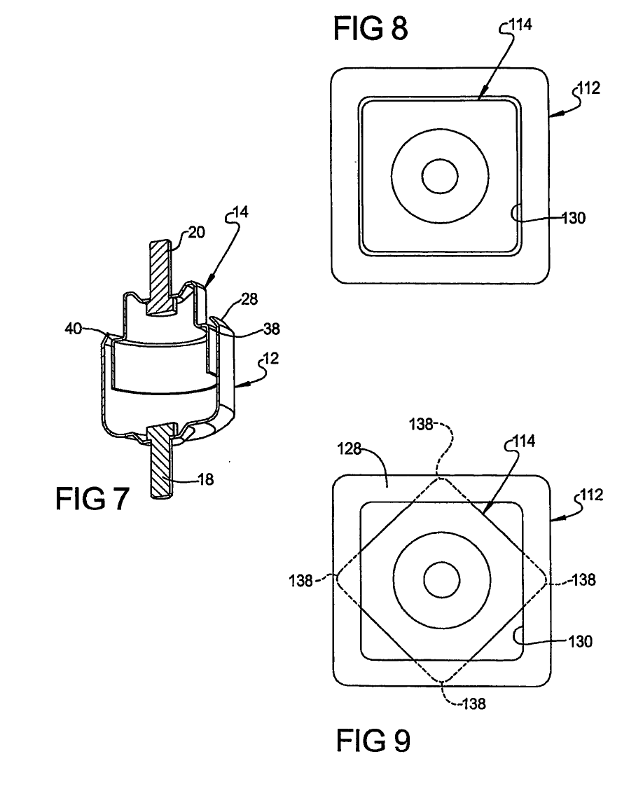

With reference to FIGS. 3-5 the assembly of the vibration reduction mount 10 according to the principles of the present invention will now be described. As illustrated in FIG. 3, the core member 14 is inserted into the opening 30 in the housing 12. Although not shown, the fasteners 18, 20 are also inserted into the mounting aperatures 24, 34 of the housing 12 and core member 14, respectively. As illustrated in FIG. 4, the core element 14 is disposed within the housing 12 and aligned with the opening 30. FIG. 5 illustrates the core element 14 being rotated 90 degrees relative to the housing 12 so that an interference is achieved between the inwardly turned flange portion 28 of the housing 12 and the respective ends 38, 40 of the core element 14. FIG. 6 is a perspective view of the core element 14 inserted in the housing 12 with the core element shown in the interlocked position so that the inwardly turned flange portion 28 provides an interference or overlap over the end portions 38, 40 of the core element 14. FIG. 7 is a partial cut away perspective view showing the interference or overlap over of the end portions 38, 40 of the core element 14.

After the core element 14 is inserted into the housing 12 and rotated to the interlocked position, the housing 12 and core element 14 are inserted into a mold in which molten elastomeric material is injected into the housing 12 in order to encapsulate the insert portion 14A of the core element 14 in order to define a spring element 16 which is disposed between the housing 12 and core element 14. The vibration reduction mount 10 according to the principles of the present invention provides side to side vibration reduction taken in a lateral direction of FIG. 1, as well side to side vibration reduction in the lateral direction of FIG. 2 which is transverse to the section taken in FIG. 1. Furthermore, due to the interference or overlap of the inwardly turned flange portion 28 overtop of the ends 38, 40 of the core element 14, an axial travel restrictor is formed to limit the amount of axial stresses that can be applied to the spring member 16.

It should be understood that many different geometries of the housing and core element can be utilized. In particular, as discussed above, the use of rectangles, oblongs and ellipses has been noted. In addition, a square configuration can also be utilized as illustrated in FIGS. 8 and 9 in which the square core element 114 is inserted into a square opening 130 provided in the generally square housing 112. The square core member 114 can then be rotated 45 degrees as illustrated in FIG. 9 in order to provide an interference of the radially inwardly turned flange portion 128 of the housing 112 overtop of the corners 138 of the core member 114. Accordingly, it can be seen that various shapes and configurations can be utilized to maintain the functionality of the present invention. It should further be recognized that combinations of different shapes can also be utilized such as a rectangular housing having a square opening for receiving a square core element. In this way, the longer length dimension of the housing will allow for more spring material to be provided for providing a tuned vibration absorbing mount that has a softer spring characteristic in the length dimension than in the width direction thereof while still maintaining an overlap or interlock of the core member within the housing.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vibration isolator for mounting between a pair of support members, comprising:
a housing adapted to be mounted to a first one of said pair of support members, said housing including a base portion, a sidewall portion extending from said base portion at a first end of said sidewall portion and an inwardly turned flange portion at a second end of said sidewall portion, said inwardly turned flange portion defining an opening having a major length dimension and a major width dimension, said major length dimension being larger than said major width dimension, said sidewall portion having a major inner length dimension and a major inner width dimension;
a core element adapted to be mounted to a second one of said pair of support members and having a portion thereof disposed within said housing, said portion of said core element having an outer length dimension that is a) smaller than said major length dimension of said opening, b) greater than said major width dimension of said opening and c) smaller than said major inner width dimension of said sidewall portion of said housing, said portion of said core element having an outer width dimension that is a) smaller than said major width dimension of said opening and b) smaller than said major length dimension of said portion of said core element, said core element being arranged in said housing such that said major length dimension of said portion of said core element extends in a same direction as said major width dimension of said opening in said housing; and
an elastomeric spring member molded between said housing and said core element.

2. The vibration isolator according to claim 1, wherein said core element includes a mounting portion extending through said opening in said housing.

3. The vibration isolator according to claim 1, wherein said opening in said housing is generally rectangular.

4. The vibration isolator according to claim 1, wherein said base portion of said housing includes a mounting aperture fro receiving a fastener therein.

5. A vibration isolator for mounting between a pair of support members, comprising:
a housing adapted to be mounted to a first one of said pair of support members, said housing including a base portion, a sidewall portion extending from said base portion at a first end of said sidewall portion and an inwardly turned flange portion at a second end of said sidewall portion, said inwardly turned flange portion defining an opening having a major length dimension and a major width dimension, said sidewall portion having a major inner length dimension and a major inner width dimension;
a core element adapted to be mounted to a second one of said pair of support members and having an insert portion thereof disposed within said housing, said insert portion of said core element having an outer length dimension that is a) smaller than said major length dimension of said opening, and b) smaller than said major inner width dimension of said sidewall portion of said housing, said portion of said core element having an outer width dimension that is smaller than said major width dimension of said opening, said core element being arranged in said housing such that a dimension of said insert portion of said core element extending in a same direction as said major width dimension of said opening in said housing is larger than said major width dimension of said opening; and
an elastomeric spring member molded between said housing and said core element.

6. The vibration isolator according to claim 5, wherein said core element includes a mounting portion extending through said opening in said housing.

7. The vibration isolator according to claim 5, wherein said opening in said housing is generally square.

8. The vibration isolator according to claim 5, wherein said base portion of said housing includes a mounting aperture for receiving a fastener therein.

9. A method of making a vibration isolator, comprising:
forming a housing having a base portion, a sidewall portion extending from said base portion at a first end of said sidewall portion and an inwardly turned flange portion at a second end of said sidewall portion, said inwardly turned flange portion defining an opening having a major length dimension and a major width dimension, said major length dimension being larger than said major width dimension, said sidewall portion having a major inner length dimension and a major inner width dimension;
forming a core element having an insert portion with an outer length dimension that is a) smaller than said major length dimension of said opening, b) greater than said major width dimension of said opening and c) smaller than said major inner width dimension of said sidewall portion of said housing, said insert portion of said core element having an outer width dimension that is a) smaller than said major width dimension of said opening and b) smaller than said major length dimension of said portion of said core element;
inserting said insert portion of said core element through said opening in said housing and rotating said core element relative to said housing such that said major length dimension of said insert portion of said core element extends in a same direction as said major width dimension of said opening in said housing; and
injecting an elastomeric material between said housing and said core element.

10. A method of making a vibration isolator, comprising:
forming a housing having a base portion, a sidewall portion extending from said base portion at a first end of said sidewall portion and an inwardly turned flange portion at a second end of said sidewall portion, said inwardly turned flange portion defining an opening therethrough;
forming a core element having an insert portion configured to fit through said opening in a first orientation and not to fit through said opening in a second orientation;
inserting said insert portion, in said first orientation through said opening in said housing;
rotating said core element relative to said housing to said second orientation; and
injecting an elastomeric material between said housing and said core element.
